(19) United States
(12) Patent Application Publication
(10) Pub. No.: US 2007/0169719 A1
(43) Pub. Date: Jul. 26, 2007

(54) An Expandable Pet Carrying Bag

(76) Inventor: Fong Chewn CHANG, Huntington Beach, CA (US)

Correspondence Address: LAW OFFICES OF J.F. LEE, 17800 CASTLETON STREET, SUITE 383, CITY OF INDUSTRY, CA, 91748, US

(21) Appl. No.: 11/277,601

(22) Filed: Mar. 27, 2006

(30) Foreign Application Priority Data
Jan. 20, 2006 (TW) 95201366

(51) Int. Cl. A01K 1/03

(52) U.S. Cl. 119/496

(57) ABSTRACT

A pet carrying bag having an expandable/collapsible sub chamber is disclosed. Two prop boards are inserted to the side vertical patches of the sub chamber, sustaining the bag in its expanded stated; the two prop boards can be stored in two bottom horizontal seam patches when the bag is in its collapsed stated. The flexibility of the present invention better accomodates pet owners' need to transport pets of varying sizes or when pet grows up in size.

### FIELD AND BACKGROUND OF THE INVENTION

Present invention relates generally to design and construction of a pet carrying bag, and especially having the attribute to accommodate the growing need of pets or the changing sizes of different pets to be carried for transportation.

FIG. 1 shows a typical pet carrying bag that is commercially available at time of this application disclosure. A bag body 12 defines a chamber 11, as shown in the carrying bag 1. Covers 121 are zippingly attached to bag body 12 by zipper sets for opening/closing, allowing pets to get in and out of said pet carrying bag 1.

The bag 1 of current art, however, lacks the flexibility to deal with the real-life situation where small pets may grow up, having their size increased consequently; or where people may have to carry pets of different sizes, at different times, using the same pet carrying bag. Using the bag 1 of current art, therefore, is ill-suited for the growing/changing size dilemma discussed herein.

Present invention solves the growing/changing size problem, by the construction of a main chamber, as defined by main material layer, and a sub chamber, as defined by sub material layer and the use of two (2) prop boards, so that the sub chamber can change in between the states of being expanded or collapsed, by putting the two prop boards in a vertical arrangement, sustaining the expanded state, or by putting the two prop boards in a horizontal arrangement when the zipper is zipped around the complete bottom circumference of the main chamber, maintaining the sub chamber in a collapsed state.

By virtue of present invention, a pet carry bag can thus be readily configured to properly fit the size of the pet to be carried for transportation purpose.

### DESCRIPTION OF THE DRAWINGS

The accompanying drawings, which are incorporated in and constitute a part of this specification, illustrate the preferred embodiment of the invention and together with the description, serve to explain the principles of the invention.

A brief description of the drawings is as follows:

FIG. 1 shows a typical prior art pet carrying bag.

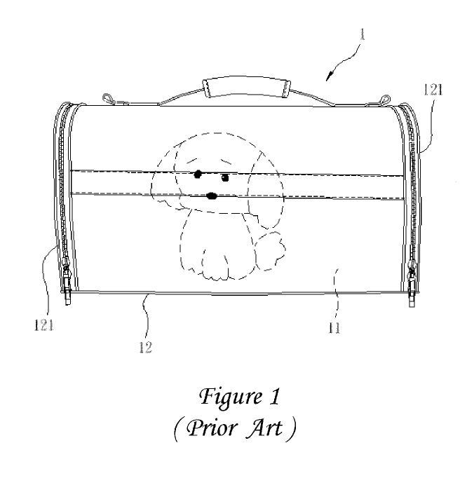

FIG. 2 shows a side view of first embodiment of present invention.

FIG. 3 shows cutout profile view of a pet carrying bag of present invention in its expanded state.

FIG. 4 shows a pet carrying bag of present invention in its expanded state, having the zipper completely unzipped all around the circumference.

FIG. 5 shows a pet carrying bag of present invention fitted to a stroller having specially designed dovetail hook-up mechanism.

FIG. 6 shows the profile view of a pet carrying bag of present invention in its collapsed state.

FIG. 7 shows the side view of a pet carrying bag of present invention in its collapsed state.

FIG. 8 shows a pet carrying bag of present invention, having a slightly sloping shape on one end of the main chamber, fitted to a stroller in its expanded stated.

FIG. 9 shows a pet carrying bag of present invention, having a slightly sloping shape on one end of the main chamber, in its collapsed state.

### DETAILED DESCRIPTION OF THE PREFERRED EMBODIMENT

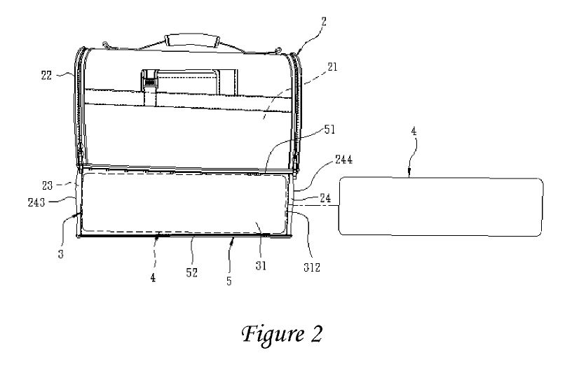

Referring to FIG. 2, a bag 2 is shown. A main chamber 21 is defined by main material layer 22. A sub chamber 23 is defined by sub material layer 24. As can been seen, sub chamber 23 is beneath main chamber 21.

There are four side surfaces 241, 242, 243 and 244 forming the four sides of sub material layer 24.

Sub material layer 24 contains seam unit 3, which is further constituted of vertical seam patches 31 and horizontal seam patches 32.

A prop board 4 is shown on the outside of bag 2, ready for insertion into one of the vertical seam spaces 311 of the seam unit 3, in vertical placement, to set the bag 2 in an expanded state, suitable for carrying bigger pets.

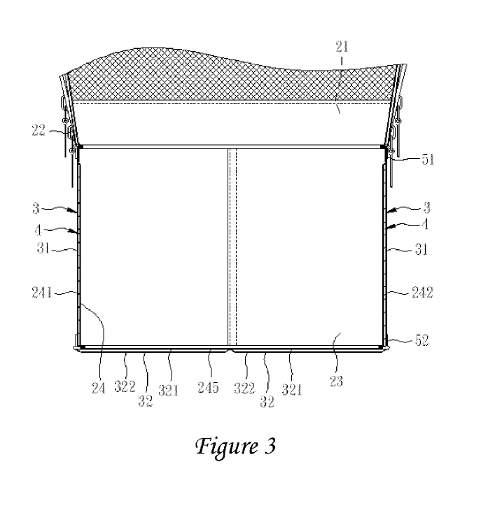

Referring to FIG. 3, the bottom 245 forms the lower surface of sub chamber 23 and contain the two horizontal seam patches 32, which further form the two horizontal seam spaces 321.

Two prop boards 4 can be stored in the two horizontal seam spaces 321 by inserting through the two horizontal seam opening 322, and having the sub chamber 23 zipped up, so as to cause the bag 2 in a collapsed state, suitable for carrying smaller pets.

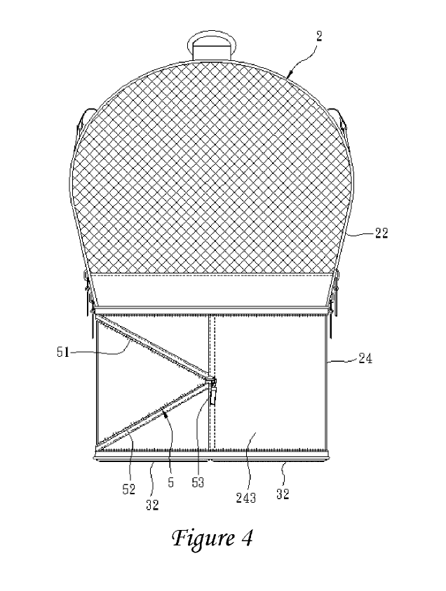

Referring to FIG. 4, a zipper set 5 has an upper zipper band 51 and a lower zipper band 52 that travels all the four surfaces 241-244 of sub chamber 23. The physical construction of the zipper set 5 to the sub material layer 24 mandates that the starting zip point be in between the upper zipper band 51 and lower zipper band 52, allowing the zipper pub tab 53 to bring the two zipper bands clsed together when going the full circle around all four sides 241-244.

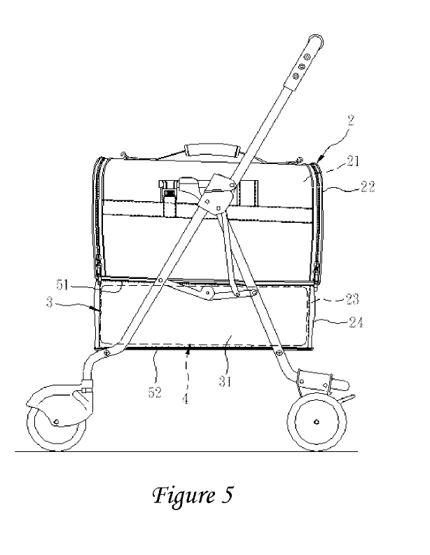

FIG. 5 shows the pet carrying bag of present invention can be loaded to a stroller having corresponding mesh-in hook, allowing the bag 2 to change in between expanded state and collapsed state.

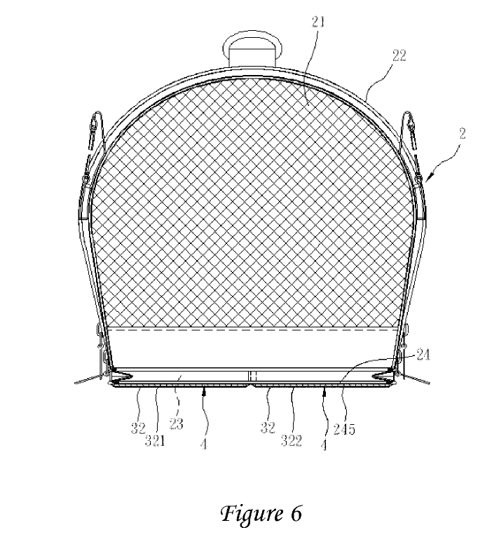

FIG. 6 shows the pet carrying bag of present invention in a collapsed stated, resulting in the collapsing of sub chamber 23, by zipping up the zipper set 5. At this collapsed stated, the two prop boards 4 are stored in the two horizontal seam spaces 321 formed at the bottom 245 of sub material layer 24.

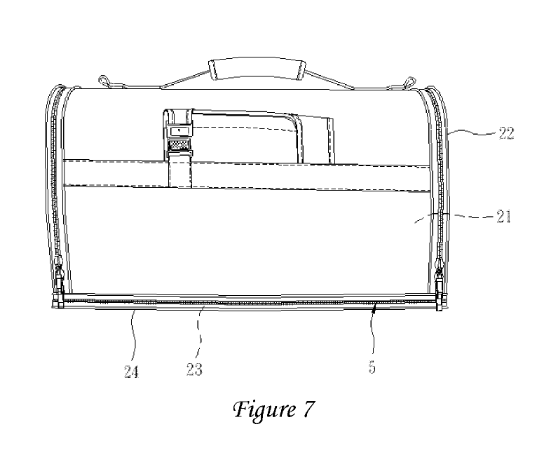

FIG. 7 shows the side view of pet carrying bag of present invention in a collapsed state, when looked from the outside.

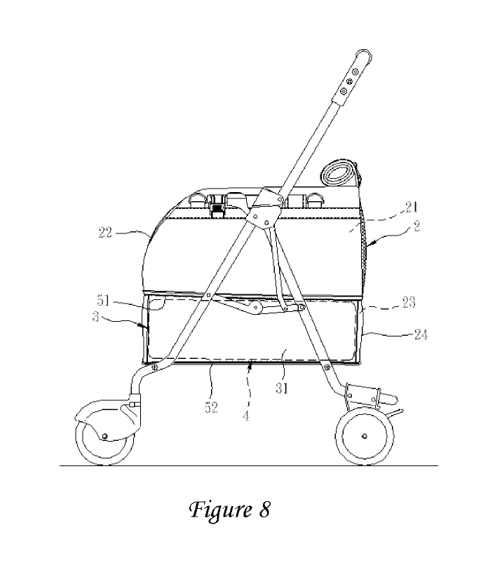

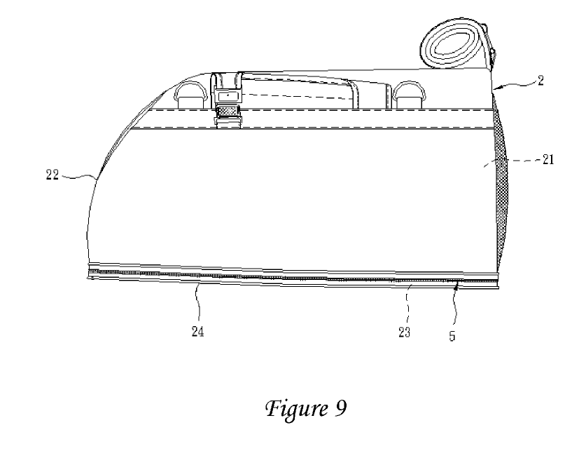

FIGS. 8-9 show a second embodiment of present invention, having a slightly sloping shape on one end of the main chamber.

What is claimed is:

1. A pet carrying bag, comprising:
a. A bag body having a main material layer defining a main chamber and a sub material layer defining a sub chamber, wherein said main and sub material layers are connected with each other, allowing said sub chamber to be varied in between expanded and collapsed state; and
b. Two prop boards that can be used to sustain the expanded state of said sub chamber or used to maintain the collapsed state of said sub chamber.

2. The pet carrying bag of claim 1, further comprising a vertical seam portion having a first vertical seam patch and a second vertical seam patch located opposite to each other on the outer vertical surface of first side and second side of said sub chamber, so as to form two vertical seam spaces wherein said prop boards can be detachably received into said two vertical seam spaces, thus sustaining said pet carrying bag in an expanded state.

3. The pet carrying bag of claim 2, further comprising a horizontal seam portion having two horizontal seam patches formed on the bottom surface of said sub chamber, so as to form two horizontal seam spaces wherein said prop boards can be detachably received into said two horizontal seam spaces, thus storing said prop boards when said pet carrying bag is in a collapsed stated.

4. The pet carrying bag of claim 3 wherein said prop boards are in a vertical arrangement when placed within said two vertical seam spaces of said vertical seam portion, so as to render sub chamber directly beneath the main chamber and in an expanded state.

5. The pet carrying bag of claim 4 further comprising a zipper fastening means having a upper zipper half surrounding the bottom circumference of main chamber and a lower zipper half surrounding the top circumference of sub chamber, so that the status of collapsing or expanding the sub chamber is achieved by zipping said two zipper halves together or unzipping said two zipper halves.
